(19) United States
(12) Patent Application Publication
(10) Pub. No.: US 2007/0273226 A1
(43) Pub. Date: Nov. 29, 2007

(54) Rotor Block

(76) Inventors: Gregor Jansen, Bottrop (DE); Thomas Dullmann, Hagen (DE); Rainer Woyck, Wetter (DE); Jorg Lindemaier, Rinteln (DE); Winfried Gievers, Wetter (DE); Hans-Hermann Osthoff, Wetter (DE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 10/590,103

(22) PCT Filed: Feb. 9, 2005
(86) PCT No.: PCT/EP05/01272

§ 371 Date: Apr. 9, 2007

(30) Foreign Application Priority Data
Feb. 19, 2004 (DE) 10 2004 008 552.8

(51) Int. Cl. H02K 5/04; H02K 5/16

(52) U.S. Cl. 310/89; 310/90

(57) ABSTRACT

The invention relates to a rotor block (1) comprising a housing (2) with at least one connection surface (3A) that absorbs the load and pivot bearing seats (4) for plain and/or anti-friction bearings (5) that are designed to support a rotor (6). To dismount the rotor (6) from the housing (2), the plain and/or anti-friction bearings (5) can be dismantled from the exterior and the rotor (6) from a side (8) lying transversally to the bearings. The pivot bearing seats (4) take the form of recesses (9) that are directly configured in the housing wall, without the use of annular bodies. To facilitate the mounting and dismounting processes and to improve the precision of the rotor alignment, the pivot bearing seats (4) are configured in such a way that they form a segment greater than a semi-circle around the plain and/or anti-friction bearings (5), leaving a section open on one side (8) in relation to said bearings (5), thus forming a narrowing (13).

The invention concerns a rotor block with a housing, with at least one connection surface that absorbs the load, and with pivot bearing seats for plain and/or anti-friction bearings that are designed to support a rotor, wherein, to dismount the rotor from the housing, the plain and/or antifriction bearings can be dismantled from the exterior and the rotor from a side lying transversally to the bearings.

Various kinds of rotor blocks are known, whose design provides for or allows for a replacement of the rotor in various ways.

The rotor blocks known from DE 31 34 750 C2 are formed from two halves of the bearing housing, which are welded together or otherwise joined, and having press-fitted pivot bearing seats in which the hub of the rotor is supported. The pivot bearing seats here are adjoined by stop shoulders for the bearings, oriented toward the hub, the rotor extends by its hub beyond the bearings and is in this way supported directly against the housing, and the hub moreover has annular grooves on its outer rings at either side, intended for snap rings lying against the end faces of the bearing, and a mounting hole with an inner thread, designed for an outer thread on a drive shaft.

This design has proven itself in practice for years. However, the need still exists to minimize costs and improve function. Replacement of the rotor of DE 31 34 750 C2 is only possible by replacing the rotor block in its entirety. After replacing, the entire rotor block has to be fastened by screws on the supporting framework—just as for the first-time installation. In this process, the rotor block needs to be aligned in its position relative to the supporting framework with the other rotors, so that the axis of rotation of the rotor lies at right angles to the rotor track on which the rotor moves. If the alignment step is not done, the danger exists that rotors will get ground down and thereby wear out faster due to skewed running on the rotor track. Furthermore, in the application of a bridge crane, the danger exists of noticeably disrupting the movement of the bridge crane due to skewed running, impacts, and wear on wheel flanges. In addition, lateral forces are created under increasing skew angles, which place a strain on the supporting framework, etc., greater than the operating strain. These issues are described at length in DIN 15018.

Another design for a rotor block is disclosed in DE 195 40 220 C1. Here, the rotor block has a housing, in which pivot bearing seats for plain and/or anti-friction bearings are provided to accommodate a rotor extending out on at least one side, and the housing can be taken apart in order to take out the rotor from one side by taking off a detachable cover, so that the housing no longer has to be loosened from the supporting framework in order to replace the rotor. However, many parts have to be loosened and tightened to install and dismount this rotor.

A further design of a rotor block is known from DE 195 40 217 C1. This calls for the use of so-called annular bodies, which serve to accommodate the bearing in the housing walls of the rotor block. For this, after the rotor with its hub is introduced, they are shoved from the outside onto the hub and its bearing and secured in the housing. With these rotors as well, the installing and dismounting involves the loosening and tightening of many parts. In particular, the annular bodies have to be removed and aligned.

While the installation and dismounting effort is less in the case of floating rotors, this is purchased at the cost of more structural expense for the bearing, without which the necessary rigidity cannot be achieved.

From DE 195 40 217 C1, moreover, there is known a rotor block in another embodiment, essentially characterized in that the bearings for the rotor are placed directly in seats that are provided in openings in the wall of the housing. To dismantle the rotor, after loosening a securing ring, the bearings are pulled out from the openings to the side. Now, in order to remove the rotor from the housing, one has to open the circumferential seat for the bearing. For this, one removes a plate closing off the housing at the side. On this plate are further arranged ridges extending into the housing, which, in the installed condition of the plate, form part of the seat for the bearing. These ridges are removed from the housing with the plate. Now, the rotor with its hub stumps protruding on either side can be taken out from the housing at the side. The hub stumps fit into the space previously enclosed by the ridges.

Furthermore, a bearing system for the rotors of cranes that is easily removable is known from DE M 19790 XI/35b. The rotor has shaft stumps emerging on either side, on each of which is arranged an enclosed bearing. The bearings have limited movement between stopping surfaces on the shaft stump. To fasten the rotor between two parallel support plates of the crane, placed at a distance from each other, two sturdy flat holding pieces are arranged on the outside of the support plates, which in the installed condition of the rotor have disk-like recesses oriented concentrically to the shaft stumps of the rotor. In addition, downward pointing slots are arranged in the support plates and the holding plates, whose width is slightly larger than the diameter of the shaft stump. To assemble the rotor, with the enclosed bearings pushed to the outside, the shaft stumps can be introduced into the slots from underneath. The enclosed bearings are then pushed in form-fitting manner onto the shaft stumps in the direction of the respective holding plates, until they engage with form fit in their disk-shaped recess. The enclosed bearings are then screwed together with the holding plates and support plates.

Therefore, the basic problem of the present invention is to facilitate the mounting and dismounting or replacement of the rotor in a rotor block.

The problem is solved by the invention reflected in claim 1.

It is possible to reduce the installation effort because the pivot bearing seats are fashioned so that they form a segment greater than a semicircle around the plain and/or anti-friction bearings and leave a section open on one side in relation to said bearings, thus forming a narrowing. Furthermore, no additional fitting is needed on each side of the bearing, so that higher accuracy of rotor alignment and higher repeating accuracy in rotor replacement are achieved. As a result, fewer skew running forces are produced, and therefore there is less wear on the rotor.

Because the openings or bearing locations are not enclosed all around, it is possible to introduce the rotor along with its hub into the housing and then secure it by pushing on the bearing.

For this, it is advantageous if the openings not enclosed all around have a narrowing that has slightly larger dimensions than the diameter of the hub of the rotor. The plain and/or anti-friction bearings can also be configured smaller than the openings not enclosed all around and larger than the narrowing.

Accordingly, the openings are free at the side so that the rotor can be taken out from the side after the plain and/or anti-friction bearings have been removed sideways. The side in this case is preferably the downward pointing side.

The openings can have a shape resembling a keyhole, looking in cross section.

The openings of the rotor block advantageously have a somewhat circular upper region to accommodate the plain and/or anti-friction bearing and a lower region forming, in particular, an angle open to the side, joined to the upper region at the narrowing. This allows for a good securing of the bearing and high stability or good absorption of the forces, as well as a secure and simple mounting and fastening of the rotor.

The somewhat circular upper region of the openings describes approximately three quarters of a circle, seen in cross section.

The connection surface can be provided on any side of the housing from which the rotor does not protrude, in particular, it is a top connection surface, arranged at the top side of the housing.

Additional features, details and benefits of the invention will be explained by means of the following description of the drawing. This shows:

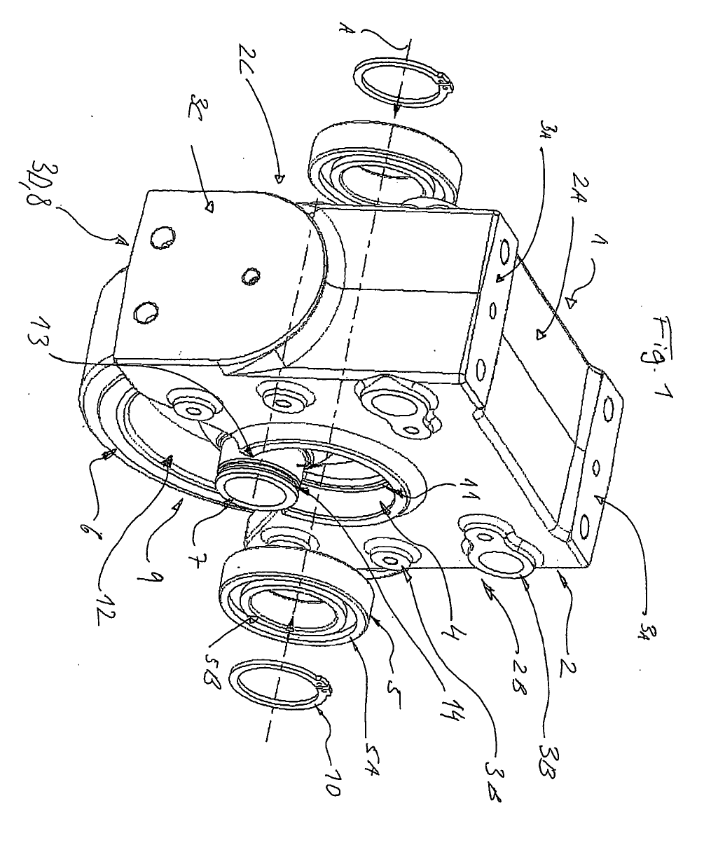

FIG. 1, a perspective exploded view of a rotor block according to the invention.

FIG. 1 shows a rotor block, designated overall as 1, with a box-shaped, single-piece housing 2 open at the bottom, at whose upper side is provided a top connection surface 3A, formed by two raised surfaces lying at the outside, extending for the width of the housing and being separated in the long direction by a lower situated region of the upper housing wall 2A.

The housing 2, moreover, has long sides 2B and end faces 2C, which likewise have raised surfaces 3B and 3C. The surfaces 3B, which surround boreholes to receive connection bolts, serve as bearing surfaces. The surface 3C is used to fasten guide rollers and buffers. The bottom side is designated as 3D or 8.

In the housing 2 there is provided a rotor 6, which turns about its axis A by its hub 7 and extends downward partly out of the housing 2 at side 8. In the usual installation position, the axis A is pointed horizontally. The hub 7 is mounted at the sides in plain and/or anti-friction bearings, which are installed in the housing 2.

Pivot bearing seats 4 are provided in the two long sides 2B of the housing, being formed directly in the housing wall by the surfaces of the openings 9. They have an upper region 11, circular in cross section, and a lower region 12, forming an angle open toward the side 8 or the bottom side 3D. Thus, the openings 9 are not completely surrounded by the housing wall and they have an approximately keyhole shaped longitudinal section. Between the upper region 11, circular in cross section, and the lower region 12, forming an angle open toward the bottom 8, there is a transition or narrowing 13, having a dimension that is slightly greater than the diameter of the hub 7. The hub 7 can thus be introduced from the bottom into the openings 9 or their upper regions 11, circular in cross section.

In the upper region 11 which is circular in cross section, plain and/or anti-friction bearings 5 are press-fitted, serving to support the ends of the hub 7. In the assembled condition, both the plain and/or anti-friction bearings 5 and the regions 11 which are circular in cross section, into which the bearings 5 are press-fitted, are aligned concentrically to the axis of rotation A of the rotor 6. Accordingly, the diameters of the plain and/or anti-friction bearings 5 are smaller than the diameter of the upper circular regions 11 and larger than the width of the narrowing 13. Thus, they do not “drop” out from the housing.

Thus, for the installation, the rotor 6 with its hub 7 is introduced into the housing 2 from the bottom, i.e., from the side 8, while the ends of the hub 7 extend into the openings 9 and are ultimately introduced into the circular regions 11.

After this, the plain and/or anti-friction bearings 5 are pushed sideways onto the hub 7 by their inner ring 5B, and introduced by their outer ring 5A into the openings 9 or their upper circular regions 11 and press-fitted there into the pivot bearing seats 4. Finally, securing rings 10 are placed on the ends of the hub 7, engaging with corresponding grooves 14 provided in the ends of the hub 7.

Due to the configuration of the rotor block 1, the rotor 2 [sic] with its hub 7 is mounted directly in the housing 2, without requiring the use of annular bodies. This, on the one hand, facilitates the installation. There are no extra parts, such as shims, on each bearing side. Moreover, the direct mounting allows for higher precision in rotor alignment and also a higher repeating precision for rotor replacement. Thus, there are fewer skew running forces and accordingly less wear on the rotor.

### LIST OF REFERENCE NUMBERS

Rotor block 1
Housing 2
Housing wall 2A
Long sides 2B
End faces 2C
Bottom side 2D
Connection surface 3A
Surface 3B, 3C
Pivot bearing seats 4
Plain and/or anti-friction bearings 5
Outer ring 5A
Inner ring 5B
Rotor 6
Hub 7
Side 8
Openings 9
Securing ring 10
Upper region 11
Lower region 12
Narrowing 13
Groove 14
Axis A

1. A rotor block, comprising:
a housing having at least one connection surface, said at least one connection surface adapted to absorb a load; and
a plurality of pivot bearing seats for at least one of plain bearings and anti-friction bearings, said bearings being designed to support a rotor, wherein the at least one of plain bearings and antifriction bearings are dismantled from an exterior of the housing and the rotor is dismantled from a side of the housing transverse to the bearings to dismount the rotor from the housing;
wherein the plurality of pivot bearing seats are adapted to form openings directly configured in the housing wall, without the use of annular bodies, wherein the plurality of pivot bearing seats are adapted to form a segment greater than a semicircle around the at least one of plain bearings and anti-friction bearings and to leave a section open on one side in relation to said bearings to form a narrowing.

2. The rotor block per claim 1, said narrowing having a larger diameter than a diameter of the hub of the rotor.

3. The rotor block per claim 1, wherein the at least one of plain bearings and anti-friction bearings are smaller than the openings, said openings not completely enclosed, and larger than the narrowing.

4. The rotor block per claim 1, wherein the openings are free at the side, wherein the rotor is taken out from the side after the at least one of plain bearings and anti-friction bearings are removed sideways.

5. The rotor block per claim 1, wherein the openings have a cross-sectional shape resembling a keyhole.

6. The rotor block per claim 1, wherein the openings have a circular upper region to accommodate the at least one of plain bearings and anti-friction bearings.

7. The rotor block per claim 6, wherein the openings have a lower region forming an angle, said angle being open to the side and joined to the circular upper region at the narrowing.

8. The rotor block per claim 6, wherein a cross section of the circular upper region of the openings comprises approximately three quarters of a circle.

9. The rotor block per claim 1, wherein the side is pointing downward.

10. The rotor block per claim 1, wherein the at least one connection surface is a top connection surface.

11. The rotor block per claim 3, wherein the openings are free at the side, wherein the rotor is taken out from the side after the at least one of plain bearings and anti-friction bearings are removed sideways.

12. The rotor block per claim 11, wherein the openings have a cross-sectional shape resembling a keyhole.

13. The rotor block per claim 12, wherein the openings have a circular upper region to accommodate the at least one of plain bearings and anti-friction bearings.

14. The rotor block per claim 13, wherein the openings have a lower region forming an angle, said angle being open to the side and joined to the circular upper region at the narrowing.

15. The rotor block per claim 14, wherein a cross section of the circular upper region of the openings comprises approximately three quarters of a circle.

16. The rotor block per claim 15, wherein the side is facing downward.

17. The rotor block per claim 16, wherein the at least one connection surface is a top connection surface.

18. A rotor block, comprising:
a housing having at least one connection surface, said at least one connection surface adapted to absorb a load;
a plurality of pivot bearing seats for at least one of plain bearings and anti-friction bearings, said bearings designed to support a rotor, wherein the at least one of plain bearings and antifriction bearings are dismantled from an exterior of the housing and the rotor is dismantled from a side of the housing transverse to the bearings to dismount the rotor from the housing;
wherein the plurality of pivot bearing seats are adapted to form openings directly configured in the housing wall, said openings each formed from a segment greater than a semicircle around the at least one of plain bearings and anti-friction bearings, said segment having an open section on one side in relation to said bearings to form a narrowing, wherein the at least one of plain bearings and anti-friction bearings are smaller than the openings and larger than the narrowing; and
wherein the openings are free at the side to allow removal of the at least one of plain bearings and anti-friction bearings and the rotor from the side.

19. The rotor block per claim 18, wherein the openings have a circular upper region to accommodate the at least one of plain bearings and anti-friction bearings.

20. The rotor block per claim 19, wherein the openings have a lower region forming an angle, said angle being open to the side and joined to the circular upper region at the narrowing.
